(19) United States
(12) Patent Application Publication
(10) Pub. No.: US 2007/0277173 A1
(43) Pub. Date: Nov. 29, 2007

(54) Job Execution Apparatus, Job Execution Method and Recording Medium

(75) Inventors: Yoshiki Tokimoto, Nishiwaki-shi (JP); Hironobu Nakata, Itami-shi (JP); Kenji Matsuhara, Kawanishi-shi (JP); Toshihiko Otake, Nishinomiya-shi (JP); Hiroaki Kubo, Muko-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/750,496

(22) Filed: May 18, 2007

(30) Foreign Application Priority Data
May 24, 2006 (JP) 2006-144700

(51) Int. Cl. G06F 9/46

(52) U.S. Cl. 718/100

(57) ABSTRACT

A job execution apparatus, comprising: an accumulator unit to accumulate jobs with their destination information; an authentication unit to perform an authentication to permit a user to execute jobs transmitted to the user and accumulated in said accumulator unit, and said authentication unit is provided inside or outside of the apparatus; a job execution unit, and a controller unit to make said job execution unit whether or not execute a job transmitted to the user who is permitted by said authentication unit to execute jobs automatically after the authentication, depending on an attribute of the job.

This application claims priority under 35 U.S.C. §119 to Japanese Patent Application No. 2006-144700 filed on May 24, 2006, the entire disclosure of which is incorporated herein by reference in its entirety.

### BACKGROUND OF THE INVENTION

1. Field of the Invention

The present invention relates to a job execution apparatus that is preferably applied to a printer that is capable of receiving data from a user terminal, etc. on a network and printing it, or an image forming apparatus such as a MFP (Multi Function Peripheral) that is a digital complex machine, a job execution method, and a recording medium in which a job execution processing program to make a computer execute job execution processing is stored.

2. Description of the Related Art

The following description sets forth the inventor's knowledge of related art and problems therein and should not be construed as an admission of knowledge in the prior art.

With this type of a job execution apparatus such as an MFP, if a print job for example, is transmitted from a user terminal comprising a personal computer (hereinafter, referred to as “PC”) on a network and the job data is directly printed out, a third person can easily find the printout.

To address the problem, an apparatus has been prevalent wherein a password is given to a print job, and a user to transmit the print job enters the password, and if the user is authorized, then the job data is printed. However, in this case, entry of a password is needed, which makes manipulation cumbersome.

In addition, when a user intends to print out a document from those accumulated in a box, etc., he/she is required to log in, select a job from those accumulated, give an instruction, and then log out. Thus, manipulation for selecting a job and giving an instruction is also cumbersome.

Consequently, in recent years, there suggested a job execution apparatus with a job execution mode (hereinafter in this specification, this job execution mode is referred to as “automatic job execution mode”), wherein simple and highly precise authentication is enabled by using a card that authentication information is preliminarily written in, or biological information, and if the authentication succeeds, a print data from those accumulated is started to be printed automatically.

For instance, Japanese Unexamined Laid-Open Patent Publication No. 2005-81763 has proposed a printer wherein ID of an authorized printer is registered in a user's IC card in advance, and a limit of access to the printer is set to each print data. Thus, an authentication whether or not it is the printer registered in advance is performed when a user sets an IC card to use the printer, and if the authentication succeeds, a print process for print data is automatically performed without user input operation after the authentication.

However, it is disadvantageous of the printer disclosed in the publication above, that under the condition where jobs (for example, fax job, etc.) transmitted by the user and those transmitted to the user by other users are mixed and accumulated, all the job data are printed when the user intends to print by “automatic job execution mode”, even if the user would like to print automatically only job data transmitted by himself/herself, and would not like to print automatically job data transmitted by other users.

To eliminate the disadvantage, there is an idea that the user selects only job data transmitted by himself/herself to have them printed, while simplified manipulation that is a benefit of using “automatic job execution mode” would not be enjoyed with this idea.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide a job execution apparatus that can limit a job to be automatically executed without losing a benefit of using “automatic job execution mode”, if a user would not like the job to be automatically executed.

It is another object of the present invention to provide a job execution method that can limit a job to be automatically executed without losing a benefit of using “automatic job execution mode” if a user would not like the job to be automatically executed.

It is yet another object of the present invention to provide a recording medium that records a job execution processing program to make a computer of a job execution apparatus, execute job execution processing.

According to a first aspect of the present invention is a job execution apparatus, comprising:
an accumulator unit to accumulate jobs with their destination information;
an authentication unit to perform an authentication to permit a user to execute jobs transmitted to the user and accumulated in said accumulator unit, and said authentication unit is provided inside or outside of the apparatus;
a job execution unit, and
a controller unit to make said job execution unit whether or not execute a job transmitted to the user who is permitted by said authentication unit to execute jobs, automatically after the authentication, depending on an attribute of the job.

According to a second aspect of the present invention is a job execution method comprising:
accumulating jobs with their destination information in an accumulator unit;
performing an authentication by an authentication unit provided inside or outside of the apparatus, to permit a user to execute jobs transmitted to the user and accumulated in said accumulator unit; and
making said job execution unit whether or not execute a job transmitted to the user who is permitted by said authentication unit to execute jobs, automatically after the authentication, depending on an attribute of the job.

According to a third aspect of the present invention is a recording medium that records a job execution processing program to make a computer execute:
accumulating jobs with their destination information in an accumulator unit;
performing an authentication by an authentication unit provided inside or outside of the apparatus, to permit a user to execute jobs transmitted to the user and accumulated in said accumulator unit; and
making said job execution unit whether or not execute a job transmitted to the user who is permitted by said authentication unit to execute jobs, automatically after the authentication, depending on an attribute of the job.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a conceptual diagram showing an image forming system in which an image forming apparatus according to one embodiment of the invention is used.

FIG. 2 is a block diagram showing an electrical configuration of the image forming apparatus.

FIG. 3 is a flowchart showing processes to be executed by a CPU of the image forming apparatus when “automatic job execution mode” is set.

FIG. 4 is a flowchart showing a subroutine of a condition checking process (Step S6) shown in FIG. 3.

FIG. 5 is a screen for setting, to set a user that “automatic job execution mode” is applied to.

FIG. 6 is a screen for setting, to set a condition to apply “automatic job execution mode” to a job attribute.

FIG. 7 is a screen for setting, to set a condition to apply “automatic job execution mode” to “originator”.

FIG. 8 is a screen for setting, to set an operation if there is a job that “automatic job execution mode” is not applied to.

FIG. 9 is a diagram showing one example of a screen for confirmation, which is displayed if there is a print job that “automatic job execution mode” is not applied to.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

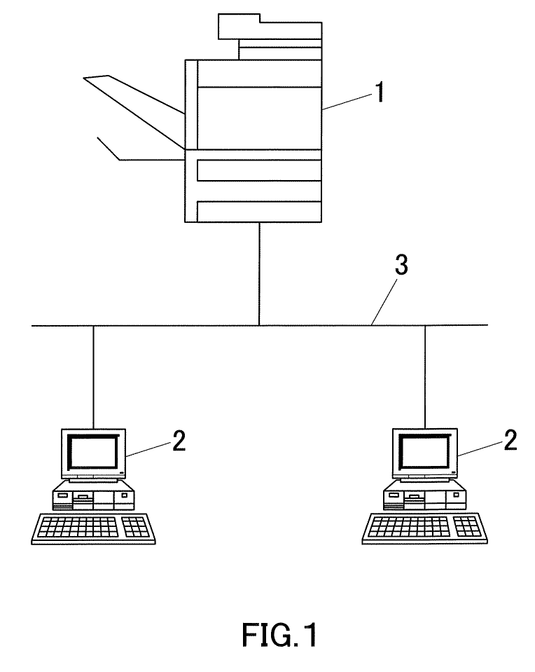

FIG. 1 is a conceptual diagram showing an image forming system in which an image forming apparatus that is a job execution apparatus according to one embodiment of the present invention is used.

As shown in FIG. 1, this image forming system comprises an MFP 1 as a job execution apparatus, and a user terminal 2 and another user terminal 2 each comprising a personal computer, etc., and the MFP 1 and the user terminals 2 are connected via a network 3 such as a LAN, etc.

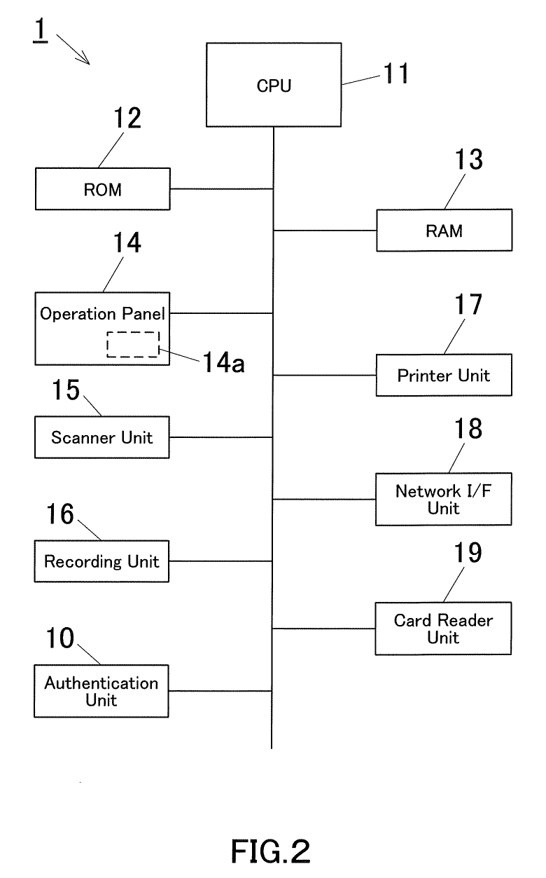

FIG. 2 is a block diagram showing an electrical configuration of the MFP 1.

The MFP 1 is a digital complex machine having various functions such as copying, printing, facsimile, scanning, e-mail transmission and etc., and it comprises a CPU 11, a ROM 12, a RAM 13, an operation panel 14, a scanner unit 15, a recording unit 16, a printer unit 17, a network interface (I/F) unit 18, a card reader unit 19, an authentication unit 10, etc., as shown in FIG. 2.

The CPU 11 controls overall operations of the MFP 1 according to an operation program stored on the ROM 12.

The ROM 12 is a memory to store the operation program for the CPU 11 and other data, while the RAM 13 is a memory to provide a working area for the CPU 11 to execute the operation program.

The operation panel 14 has a key unit (not shown in Figure) for various input manipulations and a display unit 14a.

The scanner unit 15 serves to read document image and convert it into image data.

The recording unit 16 serves to record various data and applications, and comprises a hard disk, etc. The recording unit 16 has box area where a plurality of jobs are accumulated with originator and destination information of the respective jobs.

The printer unit 17 functions as a job execution means, and prints image data of the document read by the scanner unit 15 and image data transmitted from the user terminal 2, etc.

The network I/F unit 18 functions as a communication unit to exchange data with the user terminals 2 on the network.

The card reader unit 19 contactly or contactlessly reads out authentication information such as identification information and a password that are written in an ID card (not shown in Figure) owned by a user, when the user intends to log in the MFP 1.

The authentication unit 10 serves to match authentication information read out from the card by the card reader unit 19 against authentication information recorded in advance in the recording unit 16, etc., and determine whether or not to permit the user to execute jobs. Although the authentication method using a card is adopted in this embodiment as described above, a biometric authentication method such as a method using a fingerprint, or a method using a user ID and a password entered from the operation panel 14, also can be adopted.

The authentication unit 10 performs not only a personal authentication to permit a specified user to use the MFP 1, but also an access authentication to permit a user to access box area recorded in the recording unit 10 by checking a password, etc. that is set for the box area.

Although the authentication unit 10 is incorporated in the MFP 1 in this embodiment, an external authentication unit such as an authentication server, also can be used for the authentication.

Meanwhile, the MFP 1 has “automatic job execution mode” that automatically starts executing a job transmitted to the user and recorded, if the authentication by the authentication unit 19 succeeds. In this embodiment, the CPU 11 serves to determine depending on an attribute of the job, whether or not to execute the job by “automatic job execution mode”, and control the printer unit 17 depending on the determination result.

Hereinafter, job attributes, that are criteria to determine whether or not to execute a job by “automatic job execution mode”, will be explained.

### (1) File Attribute

Usually, a print job transmitted by a user is written by a printer driver, in a printer language. Thus, it can be configured that only a print job written in a printer language is printed while other jobs such as confidential, FAX, and TIFF-format, are not printed. In addition, it also can be configured that “automatic job execution mode” is applied or not applied only to a job with a specified extension such as “pdf”, “doc” or “xls”

In addition, it also can be configured by job types. For instance, it can be configured that “automatic job execution mode” is applied or not applied to a job depending on a type of the job, such as a print job, a copy job, or a FAX job.

In addition, it also can be configured that “automatic job execution mode” is applied or not applied to all the jobs.

Otherwise, if there is a job that “automatic job execution mode” is not applied to, a screen to confirm whether or not to execute the job is displayed on the display unit 14a for the user, and then the job is executed by user operation to select job execution.

### (2) Originator (Sender)

It can be configured that “automatic job execution mode” is applied or not applied to a job depending on an originator (sender) of the job. Usually, it is configured that the mode is applied only to a job transmitted by the user himself/herself. However, it also can be configured that “automatic job execution mode” is applied to a job transmitted from another originator only if he/she is a trustworthy person, a group member, etc.

In addition, it also can be configured that “automatic job execution mode” is applied or not applied to all the jobs without depending on the job originators.

Otherwise, if there is a job that “automatic job execution mode” is not applied to, it also can be configured that a screen to confirm whether or not to execute the job is displayed on the display unit 14a for the user, and then the job is executed by user operation to select job execution.

### (3) Time

It can be configured that “automatic job execution mode” is applied or not applied to a job depending on time of receiving the job. A user goes and picks up his/her outputs soon after transmitting a print job as usual, or the user also can specify valid duration of “automatic job execution mode”. For instance, it can be configured “automatic job execution mode” is applied to a job just for a predetermined period of time (such as 3, 5, 10 or 30 minute) after receiving the job, while it is not applied to any job that is received after expiration. In addition, it also can be configured “automatic job execution mode” is applied to a job at a predetermined time.

### (4) Location for Accumulation

It can be configured that“automatic job execution mode” is applied to a job recorded in a specific box or directory of the recording unit 16. Usually, a job transmitted by a user is recorded in a box owned by the user himself/herself, and it is configured that “automatic job execution mode” is applied only to a job recorded in a box owned by the user himself/herself. In addition, it also can be configured that “automatic job execution mode” is applied only to a job recorded in a box that is created or specified by the user.

### (5) Job Mode

For instance, it can be configured that “automatic job execution mode” is applied only to a job to be executed by monochrome mode. This configuration is advantageous specifically for a department where color printing is properly managed.

If there is a job to be executed by full-color mode, it can be configured that the user is required to confirm how the job preferably to be executed, at a timing of authentication or others. For instance, even though the user intended to transmit a job including a monochrome document only, if it is determined by an ACS, etc. that the job includes a full-color document, the user is required to confirm at a timing of authentication, how the job including a full-color document to be executed, that is, to be printed as is in full colors, converted and printed in monochrome, or deleted.

### (6) Upper Limit

It can be configured that “automatic job execution mode” is applied to a job only if the number of printed sheets of paper does not exceed a predetermined upper limit.

If the job is not printed due to the upper limit, a screen for confirmation is displayed in the display unit 14a of the operation panel 14.

### (7) Volume

It can be configured that “automatic job execution mode” is applied to a job depending on number of pages included in the job, that is, only if the job includes less pages than a predetermined number. If there is a job including more pages than the predetermined number, a screen for confirmation is displayed in the display unit 14a of the operation panel 14.

### (8) Double-Side/Multiple Pages per Sheet

If there is a job including more than one page, the job can be printed in double sides or in multiple pages per sheet. It can be configured that “automatic job execution unit” is applied to a job only if the job includes only one page, while an indication is displayed in the display unit 14a of the operation panel 14 for the user to confirm how the job preferably to be printed, in double sides or multiple pages per sheet, if the job includes more than one page.

The job attributes described above are taken just for examples, and it is not necessary to set a condition to apply “automatic job execution mode” about each of the job attribute, and only necessary to set a condition at least about one of the job attributes. In addition, it also can be configured that a conditions to apply “automatic job execution mode” is set about each of a plurality of job attributes, and “automatic job execution mode” is applied only to a job that fulfills the conditions set about each of them.

In addition, it also can be configured that “automatic job execution mode” is applied to a job depending on a combination of job attributes. For instance, it is configured that “automatic job execution mode” is basically applied to a job originated by the user himself/herself, while “automatic job execution mode” is not applied to a job even though the job is originated by the user himself/herself if a condition to apply “automatic job execution mode” is not set about the other job attribute.

If there is a job that “automatic job execution mode” is not applied to, a screen to confirm whether or not to execute the job can be displayed in the display unit 14a of the operation panel 14.

The screen for confirmation can display a list of jobs that “automatic job execution mode” is not applied to, for the user not only to select a job to be executed from the list but also to specify how the job to be executed, before or during job execution by “automatic job execution mode”.

In addition, if there is a job that “automatic job execution mode” is not applied to, it can be configured that “automatic job execution mode” is disabled and a warning of it is displayed.

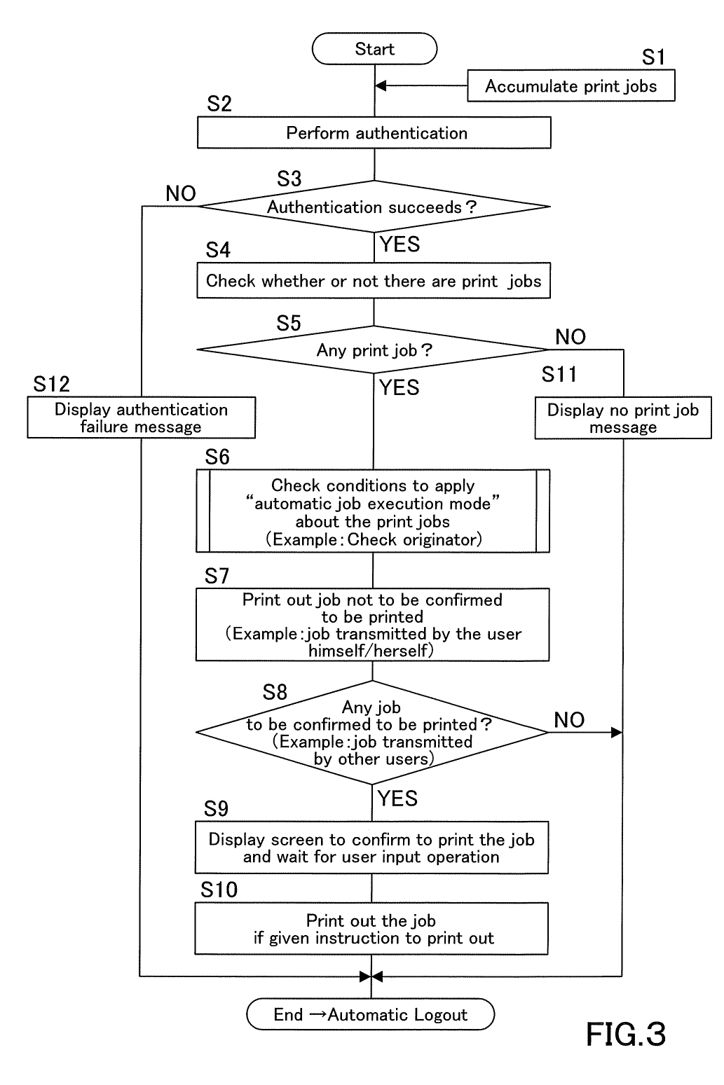

Hereinafter, processes executed by the CPU 1 when “automatic job execution mode” is set on the MFP 1, will be explained with reference to the flowchart in FIG. 3.

If a print job is received, it is recorded in a specified box in the recording unit 16, in Step S1 shown in FIG. 3. Then, user authentication using an ID card for instance is performed in Step S2, and it is determined in Step S3 whether or not the authentication succeeded.

If the authentication does not succeed (NO in Step S3), an authentication failure message is displayed in the display unit 14a of the operation panel 14, in Step S12. Then, the user is automatically logged out and the routine terminates. If the authentication succeeds (YES in Step S3), it is checked in Step S4 whether or not there are print jobs, and it is determined in Step S5 whether or not there is any print job transmitted to the user among those.

If there is a print job transmitted to the user (YES in Step S5), then in Step S6, a condition to apply “automatic job execution mode”, is confirmed by checking an attribute, for example job originator (sender), of the print job. Then, the job is printed out in Step S7, if it can be printed without confirmation, in other words, it is the job that “automatic job execution mode” is applied to, and then the routine proceeds to Step S8. If there is no print job transmitted to the user (NO in Step S5), a no print job message is displayed in the display unit 14a in Step S11. Then the user is automatically logged out and the routine terminates.

In Step S8, it is determined whether or not there is a job to be confirmed whether or not to be printed, in other words, there is a job that “automatic job execution mode” is not applied to (for example a job transmitted from an other user). If there is no job to be confirmed whether or not to be printed (NO in Step S8), the user is automatically logged out and the routine directly terminates. If there is a job to be confirmed whether or not to be printed (YES in Step S8), then a screen to confirm whether or not to print the job is displayed in the display unit 14a and the routine waits for user input operation, in Step S9. Subsequently, an instruction to print the job is given by user input operation in Step S10, and the job is printed out. Then, the user is logged out and the routine terminates.

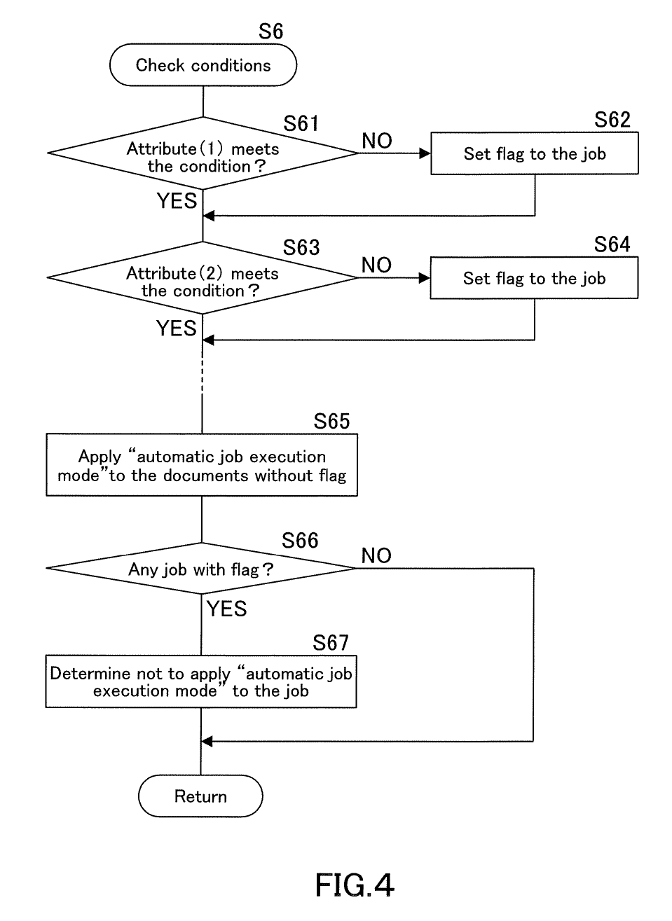

FIG. 4 is a flowchart showing a subroutine to check conditions to apply “automatic job execution mode” in Step S6 shown in FIG. 3. In this example, “automatic job execution mode” is applied to a job only if each of the job attributes described above fulfills the condition to apply “automatic job execution mode”.

In Step S61 of FIG. 4, it is determined whether or not an attribute (1) of the print job meets the condition to apply “automatic job execution mode”. If it meets (YES in Step S61), the routine proceeds to Step S63, and if does not meet (NO in Step S61), a flag is set to the job in Step S62, and the routine proceeds to Step S63.

In Step S63, it is determined whether or not an attribute (2) of the print job meets the condition to apply “automatic job execution mode”. If it meets (YES in Step S63), the routine goes to check a next attribute, and if does not meet (NO in Step S63), a flag is set to the job in Step S64, then the routine goes to check a next attribute.

After completion of checking whether or not each of the attributes of the existing print jobs meet the set condition, the routine proceeds to Step S65, and it is determined that “automatic job execution mode” is applied to print jobs without flag.

Subsequently, it is determined in Step S66 whether or not there is any job with flag. If there is no job with flag (NO in Step S66), the routine directly returns. If there is any job with flag (YES in Step S66), it is determined in Step S67 that “automatic job execution mode” is not applied to the job, and then the routine directly returns.

In sum, a control is performed on a print job transmitted to a user who is permitted by the authorization unit 10 to execute jobs, to determine whether or not to print the print job automatically after the authorization depending on attributes of the print job. Therefore, “automatic job execution mode” is applied to a job that the user prefers to execute automatically, and the user can enjoy the benefit of using “automatic job execution mode”, which is simplified manipulation. Meanwhile, the user can limit a job that he/she does not prefer to execute automatically. Thus, this satisfies the user's need and contributes to user friendliness.

In the following, how to set a condition to apply “automatic job execution mode” via the display unit 14a of the operation panel 14, will be explained.

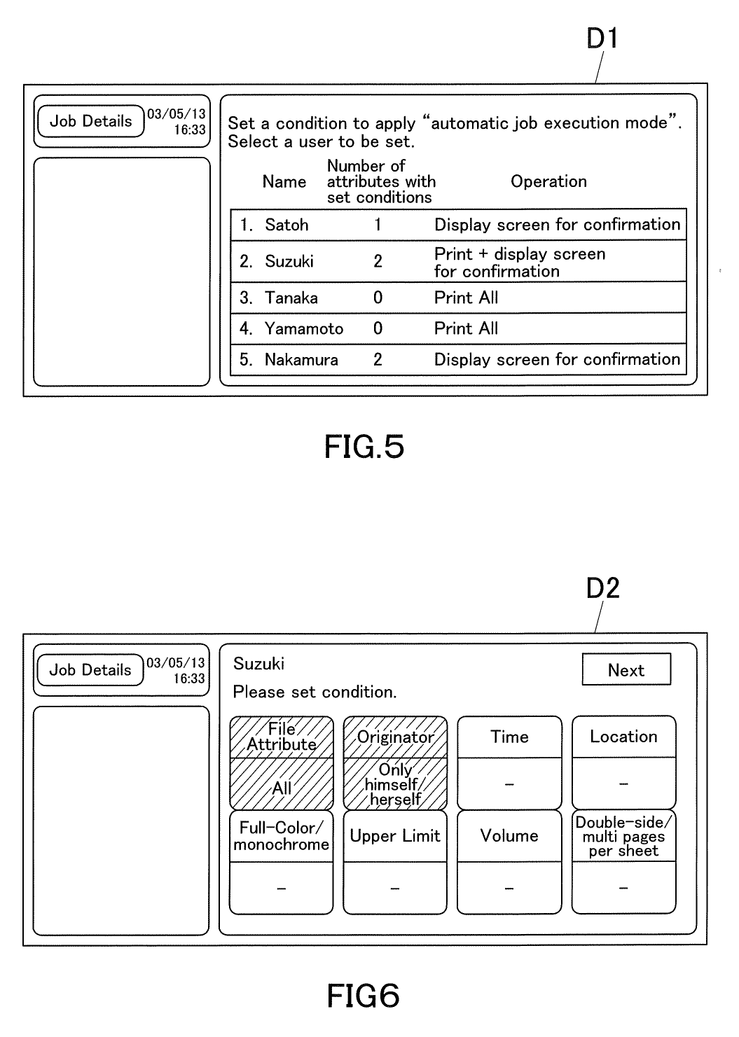

A user is selected in a screen D1 for setting, shown in FIG. 5. A list of the users who are candidates to be permitted to execute jobs by “automatic job execution mode” is displayed, and a target user is selected from those, in the screen D1. Then, the screen is switched to a screen D2 shown in FIG. 6. It is noted that the number of job attributes with set conditions, and the configuration report, is also displayed in the screen D1.

Subsequently, not only keys corresponding to the respective job attributes (file attribute, originator, time, location, full-color/monochrome, upper limit, volume, and double-side/multi pages per sheet), but also current conditions set for the respective keys, are displayed in the screen D2 shown in FIG. 6. For instance, a setting about “file attribute” is that “automatic job execution mode” is applied to a job having any file attribute, and a setting about “originator” is that “automatic job execution mode” is applied only to a job transmitted by the user himself/herself. To add/delete a condition, the screen is switched to a screen for condition setting by pressing a corresponding key.

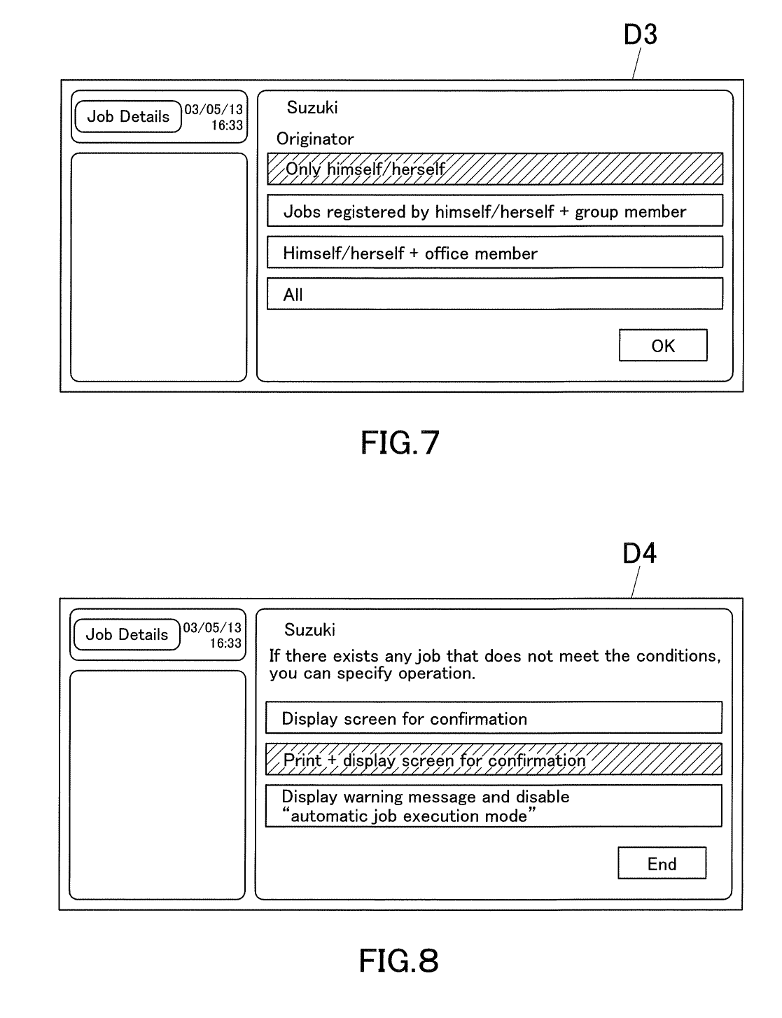

FIG. 7 illustrates a screen D3 for condition setting that is displayed when the “originator” key is pressed in the screen D2 shown in FIG. 6.

In the screen D3, there are the items, “only himself/herself”, “job registered by himself/herself+group member”, “himself/herself+office member” and “all” as job originator(s) that is a condition to apply “automatic job execution mode”. By selecting an item from those and pressing an “OK” button, the condition is determined.

FIG. 8 illustrates a screen D4 for operation setting. If there is a job not satisfying the conditions set in FIG. 5 to FIG. 7 (a job that “automatic job execution mode” is not applied to), operations to be performed on the job can be specified in the screen D4.

In the screen D4, an item can be selected from “display screen for confirmation”, “print+display screen for confirmation” and “display warning message and disable ‘automatic job execution mode’”, and the selection is determined by pressing an “end” button. The “display screen for confirmation” means to display a screen to specify an operation to be performed on a job that “automatic job execution mode” is not applied, before job execution by “automatic job execution mode”. The “print+display screen for confirmation” means to execute a job by “automatic job execution mode” and display a screen for confirmation at the same time. The “display warning message and disable ‘automatic job execution mode’” means to disable “automatic job execution mode” and display a warming of it at the same time.

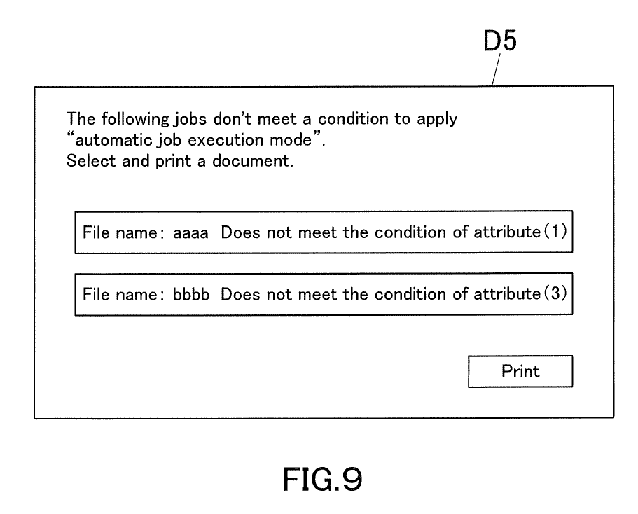

FIG. 9 illustrates one example of a screen to confirm an operation to be performed on a job that “automatic job execution mode” is not applied to.

In a screen D5 for confirmation, there displayed jobs that “automatic job execution mode” is not applied to, with a message for the user to encourage selecting a job and giving an instruction to print it, file names of the jobs, job attributes that do not satisfy the conditions to apply “automatic job execution unit”. By selecting a file that is a job and pressing a “print” button, the selected file is started to be printed.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A job execution apparatus, comprising:
an accumulator unit to accumulate jobs with their destination information;
an authentication unit to perform an authentication to permit a user to execute jobs transmitted to the user and accumulated in said accumulator unit, and said authentication unit is provided inside or outside of the apparatus;
a job execution unit, and
a controller unit to make said job execution unit whether or not execute a job transmitted to the user who is permitted by said authentication unit to execute jobs, automatically after the authentication, depending on an attribute of the job.

2. The job execution apparatus as recited in claim 1, wherein said attribute of the job corresponds at least to one from job originator, file attribute, job type, time, location for accumulation, job mode, upper limit assigned to the user, and job volume.

3. The job execution apparatus as recited in claim 1 comprising a display unit, wherein said controller unit makes said display unit display a screen for the user to confirm whether or not to execute the job that is not executed by said job execution unit automatically after the authentication.

4. The job execution apparatus as recited in claim 1, wherein:
said accumulator unit also accumulates job originator information;
said attribute of the job corresponds to job originator; and
said controller unit makes a job executed automatically after the authentication if the job originator is the user who is permitted to execute jobs, meanwhile, it makes a job not executed automatically if the job originator is not the user who is permitted to execute jobs.

5. The job execution apparatus as recited in claim 4, wherein said controller unit makes a job whether or not executed automatically after the authentication, depending on an attribute of the job other than job originator, even if the job originator is the user who is permitted by the authentication to execute jobs.

6. The job execution apparatus as recited in claim 1, comprising a configuration unit to configure by user manipulation, a setting that makes said job execution unit whether or not execute a job automatically after the authentication depending on an attribute of the job.

7. The job execution unit as recited in claim 1, wherein the job is a print job.

8. A job execution method, comprising:
accumulating jobs with their destination information in an accumulator unit;
performing an authentication by an authentication unit provided inside or outside of the apparatus, to permit a user to execute jobs transmitted to the user and accumulated in said accumulator unit; and
making said job execution unit whether or not execute a job transmitted to the user who is permitted by said authentication unit to execute jobs, automatically after the authentication, depending on an attribute of the job.

9. The job execution method as recited in claim 8, wherein said attribute of the job corresponds at least to one from job originator, file attribute, job type, time, location for accumulation, job mode, upper limit assigned to the user, and job volume.

10. The job execution method as recited in claim 8, wherein said display unit is made display a screen for the user to confirm whether or not to execute the job that is not executed by said job execution unit automatically after the authentication, in said controlling step.

11. The job execution method as recited in claim 8, wherein:
job originator information is also accumulated in the accumulator unit, in said accumulation step;
said attribute of the job corresponds to job originator; and
the job is made executed automatically after the authentication if the job originator is the user who is permitted to execute jobs, meanwhile, the job is not made executed automatically if the job originator is not the user who is permitted to execute jobs, in said controlling step.

12. The job execution method as recited in claim 11, wherein the job is made whether or not executed automatically after the authentication, depending on an attribute of the job other than job originator, even if the job originator is the user who is permitted by the authentication to execute jobs, in said controlling step.

13. The job execution method as recited in claim 8, comprising the step of configuring by user manipulation, a setting that makes said job execution unit whether or not execute a job automatically after the authentication depending on an attribute of the job.

14. The job execution method as recited in claim 8, wherein the job is a print job.

15. A recording medium that records a job execution processing program to make a computer execute:
accumulating jobs with their destination information in an accumulator unit;
performing an authentication by an authentication unit provided inside or outside of the apparatus, to permit a user to execute jobs transmitted to the user and accumulated in said accumulator unit; and
making said job execution unit whether or not execute a job transmitted to the user who is permitted by said authentication unit to execute jobs, automatically after the authentication, depending on an attribute of the job.

16. The recording medium as recited in claim 15, recording said job execution processing program, wherein said attribute of the job corresponds at least to one from job originator, file attribute, job type, time, location for accumulation, job mode, upper limit assigned to the user, and job volume.

17. The recording medium as recited in claim 15, recording said job execution processing program, wherein said display unit is made display a screen for the user to confirm whether or not to execute the job that is not executed by said job execution unit automatically after the authentication, in said controlling step.

18. The recording medium as recited in claim 15, recording said job execution processing program, wherein:
job originator information is also accumulated in the accumulator unit, in said accumulation step;
said attribute of the job corresponds to job originator; and
the job is made executed automatically after the authentication if the job originator is the user who is permitted to execute jobs, meanwhile, the job is not made executed automatically if the job originator is not the user who is permitted to execute jobs, in said controlling step.

19. The recording medium as recited in claim 18, recording said job execution processing program, wherein the job is made whether or not executed automatically after the authentication, depending on an attribute of the job other than job originator, even if the job originator is the user who is permitted by the authentication to execute jobs, in said controlling step.

20. The recording medium as recited in claim 15, recording said job execution processing program, wherein said job execution processing program comprises the step of configuring by user manipulation, a setting that makes said job execution unit whether or not execute a job automatically after the authentication depending on an attribute of the job.

21. The recording medium according to claim 15, recording said job execution processing program, wherein the job is a print job.
